(19) United States
(12) Patent Application Publication
(10) Pub. No.: US 2017/0221011 A1
(43) Pub. Date: Aug. 3, 2017

(54) SYSTEM, METHOD, AND MACHINE-READABLE MEDIUM FOR MANAGING NETWORK-CONNECTED INDUSTRIAL ASSETS

(71) Applicant: General Electric Company, Schenectady, NY (US)

(72) Inventors: Johannes Von Sichart, San Ramon, CA (US); Runn Vermel, San Ramon, CA (US); Genghis Mendoza, San Ramon, CA (US); Katherine Menkaus, San Ramon, CA (US); Sean P. O'Connor, San Ramon, CA (US); Lauren Renee Bridge, San Ramon, CA (US); Wai Loon Fong, San Ramon, CA (US); John Miles Rogerson, Moss Beach, CA (US)

(21) Appl. No.: 15/087,927

(22) Filed: Mar. 31, 2016

Related U.S. Application Data
(60) Provisional application No. 62/289,743, filed on Feb. 1, 2016.

(51) Int. Cl. G06Q 10/10; G06F 3/0482; H04L 12/26; G06F 3/0484; H04L 29/08; H04L 29/06

(52) U.S. Cl. CPC G06Q 10/1093; H04L 67/02; H04L 65/4076; H04L 43/045; G06F 3/04842; G06F 3/0482

(57) ABSTRACT

This disclosure provides for a system and method for managing network-connected industrial assets. A user may request monitored data for one or more of the network-connected industrial assets using a client device that is communicatively coupled to an Industrial Internet of Things (IIoT) machine. The IIoT machine monitors and records data for various metrics for one or more industrial assets communicatively coupled to the IIoT machine. Using the client device, the user defines a timeframe that the IIoT machine has recorded data for one or more of the more industrial assets. In response to a calendar event broadcast by a calendar web component of the client device, other web components communicate with the IIoT machine to receive and display the recorded data.

### CLAIM OF PRIORITY

This application claims the benefit of priority under 35 U.S.C. §119(e) to U.S. Provisional Patent Application Ser. No. 62/289,743, filed on Feb. 1, 2016, the benefit of priority of which is claimed hereby, and which is incorporated by reference herein in its entirety.

### TECHNICAL FIELD

The subject matter disclosed herein generally relates to managing network-connected industrial assets and, in particular, to obtaining monitored data for one or more network-connected industrial assets according to a timeframe defined by a calendar Web component.

### BACKGROUND

Software-implemented processes have a direct influence over many aspects of society. Digital consumer companies are disrupting the old guard and changing the way we live and do business in fundamental ways. For example, recent companies have disrupted traditional business models for taxis, hotels, and car rentals by leveraging software-implemented processes and interfaces to create new business models that better address consumers' needs and wants.

An Internet of Things (IoT) has developed over at least the last decade, representing a network of physical objects or “things” with embedded software that enables connectivity with other similar or dissimilar things. In some examples, connected things can exchange information, or can receive remote instructions or updates, for example via the Internet. Such connectivity can be used to augment a device's efficiency or efficacy, among other benefits.

Similarly to the way that consumer device connectivity is changing consumers' lifestyles, embedded software and connectivity among industrial assets presents an opportunity for businesses to alter and enhance operations, for example in fields of manufacturing, energy, agriculture, or transportation, among others. This connectivity among industrial assets is sometimes referred to as the Industrial Internet of Things (IIoT).

Industrial Internet applications are typically isolated, one-off implementations. However, these implementations limit the opportunities to create economies of scale, and fall short of unlocking the potential of connecting multiple machines and data around the globe.

### BRIEF DESCRIPTION OF THE DRAWINGS

Some embodiments are illustrated by way of example and not limitation in the figures of the accompanying drawings.

FIG. 1 is a block diagram illustrating an asset management platform, according to an example embodiment.

FIG. 2 is a block diagram illustrating different edge connectivity options that an IIoT machine provides, in accordance with an example embodiment.

FIG. 3 illustrates a client device of FIG. 2, according to an example embodiment.

FIG. 4 illustrates a graphical user interface for interacting with a calendar Web component, according to an example embodiment.

FIG. 5 illustrates the effect of selecting dates on a displayed graphical calendar, according to an example embodiment.

FIGS. 6-7 illustrate the effect of selecting an ending date first and a starting date second on a displayed graphical calendar, according to an example embodiment.

FIG. 8 illustrates a graphical user interface displaying monitored data in response to a broadcasted calendar event, according to an example embodiment.

FIGS. 9A-9C illustrate a method, in accordance with an example embodiment, for requesting monitored data using a calendar web component.

FIG. 10 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

Example methods and systems are directed to managing industrial assets in communication with a network cloud and, in particular, to managing the industrial assets via a client device communicatively coupled to an IIoT machine. The IIoT machine is configured to record data for one or more industrial assets communicatively coupled to the IIoT machine. The client device is configured with a calendar web component that allows a user to define a timeframe corresponding to the time during which the IIoT machine recorded data. Furthermore, the calendar web component includes various input elements that allow the user to specify the timeframe with a high-degree of granularity. The technical benefit of such specificity is that a user can pinpoint an exact or probable time when a problem or other deviation may have occurred with respect to a given industrial asset.

Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

Industrial equipment or assets, generally, are engineered to perform particular tasks as part of a business process. For example, industrial assets can include, among other things and without limitation, manufacturing equipment on a production line, wind turbines that generate electricity on a wind farm, healthcare or imaging devices (e.g., X-ray or magnetic resonance imaging (MRI) systems) for use in patient care facilities, or drilling equipment for use in mining operations. The design and implementation of these assets often takes into account both the physics of the task at hand, as well as the environment in which such assets are configured to operate.

Low-level software and hardware-based controllers have long been used to drive industrial assets. However, with the rise of inexpensive cloud computing, increasing sensor capabilities, and decreasing sensor costs, as well as the proliferation of mobile technologies, there are new opportunities to enhance the business value of some industrial assets.

While progress with industrial equipment automation has been made over the last several decades, and assets have become ‘smarter,’ the intelligence of any individual asset pales in comparison to intelligence that can be gained when multiple smart devices are connected together. Aggregating data collected from or about multiple assets can enable users to improve business processes, for example by improving effectiveness of asset maintenance or improving operational performance.

In an example, an industrial asset can be outfitted with one or more sensors configured to monitor an asset's operations or conditions. The data from the one or more sensors can be recorded or transmitted to a cloud-based or other remote computing environment. By bringing such data into a cloud-based computing environment, new software applications can be constructed, and new physics-based analytics can be created. Insights gained through analysis of such data can lead to enhanced asset designs, or to enhanced software algorithms for operating the same or similar asset at its edge, that is, at the extremes of its expected or available operating conditions.

Systems and methods described herein are configured for managing industrial assets. In an example, information about industrial assets and their use conditions, such as gathered from sensors embedded at or near industrial assets themselves, can be aggregated, analyzed, and processed in software residing locally or remotely from the assets. In an example, applications configured to operate at a local or remote processor can be provided to optimize an industrial asset for operation in a business context. In an example, a development platform can be provided to enable end-users to develop their own applications for interfacing with and optimizing industrial assets and relationships between various industrial assets and the cloud. Such end-user-developed applications can operate at the device, fleet, enterprise, or global level by leveraging cloud or distributed computing resources.

The systems and methods for managing industrial assets can include or can be a portion of an Industrial Internet of Things (IIoT). In an example, an IIoT connects industrial assets, such as turbines, jet engines, and locomotives, to the Internet or cloud, or to each other in some meaningful way. The systems and methods described herein can include using a “cloud” or remote or distributed computing resource or service. The cloud can be used to receive, relay, transmit, store, analyze, or otherwise process information for or about one or more industrial assets.

In an example, a cloud computing system includes at least one processor circuit, at least one database, and a plurality of users or assets that are in data communication with the cloud computing system. The cloud computing system can further include or can be coupled with one or more other processor circuits or modules configured to perform a specific task, such as to perform tasks related to asset maintenance, analytics, data storage, security, or some other function, as further described herein.

In an example, a manufacturer of industrial assets can be uniquely situated to leverage its understanding of industrial assets themselves, models of such assets, and industrial operations or applications of such assets, to create new value for industrial customers through asset insights. In an example, an asset management platform (AMP) can incorporate a manufacturer's asset knowledge with a set of development tools and best practices that enables asset users to bridge gaps between software and operations to enhance capabilities, foster innovation, and ultimately provide economic value.

In an example, an AMP includes a device gateway that is configured to connect multiple industrial assets to a cloud computing system. The device gateway can connect assets of a particular type, source, or vintage, or the device gateway can connect assets of multiple different types, sources, or vintages. In one embodiment, the multiple connected assets belong to different asset communities (e.g., logical and/or physical groups of assets that are assigned by the end user and/or by the AMP), and the asset communities are located remotely or locally to one another. The multiple connected assets are in use (or non-use) under similar or dissimilar environmental conditions, or can have one or more other common or distinguishing characteristics. For example, information about environmental or operating conditions of an asset or an asset community can be shared with the AMP. Using the AMP, operational models of one or more assets can be improved and subsequently leveraged to optimize assets in the same community or in a different community.

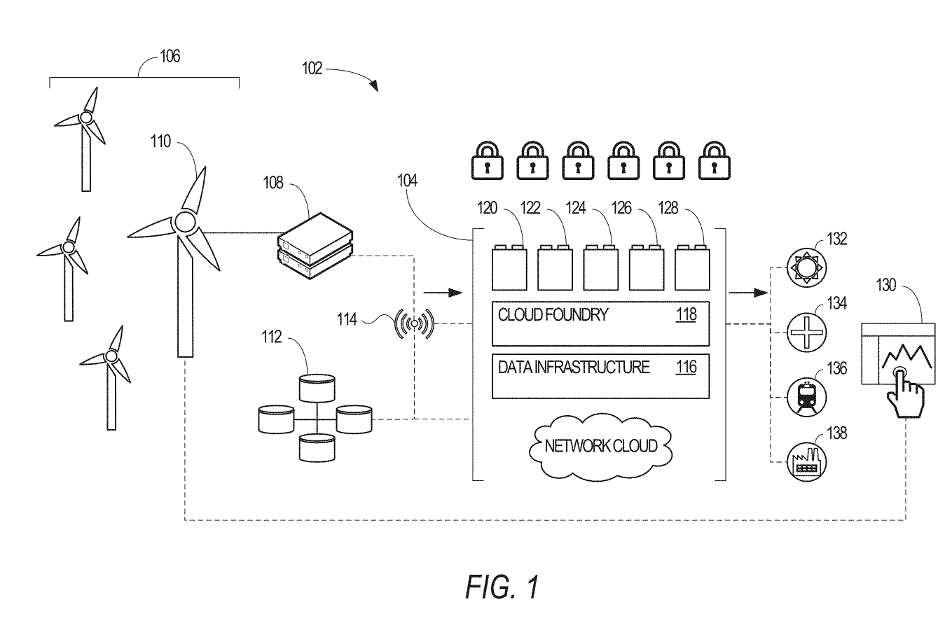

FIG. 1 is a block diagram illustrating an asset management platform (AMP) 102, according to an example embodiment. In various embodiments, one or more portions of the AMP 102 reside in an asset cloud computing system 104, in a local or sandboxed environment, or can be distributed across multiple locations or devices. The AMP 102 may be configured to perform any one or more of data acquisition, data analysis, or data exchange with local or remote assets, or with other task-specific processing devices.

In one embodiment, the AMP 102 includes an asset community 106 that is communicatively coupled with the asset cloud computing system 104. An IIoT machine 108 is communicatively coupled with one or more of the assets of the asset community 106. The IIoT machine 108 receives information from, or senses information about, at least one asset member 110 of the asset community 106, and configures the received information for exchange with the asset cloud computing system 104. In one embodiment, the IIoT machine 108 is communicatively coupled to the asset cloud computing system 104 or to an enterprise computing system 112 via a communication gateway 114. The communication gateway 114 may use one or more wired and/or wireless communication channels that extend at least from the IIoT machine 108 to the asset cloud computing system 104.

In one embodiment, the asset cloud computing system 104 is configured with several different and/or similar layers. For example, the asset cloud computing system 104 may include a data infrastructure layer 116, a Cloud Foundry layer 118, and one or more modules 120-128 for providing various functions. In one embodiment, the data infrastructure layer 116 provides applications and/or services for accessing data maintained by the asset cloud computing system 104. In addition, the Cloud Foundry layer 118 executes Cloud Foundry, which is an open source platform-as-a-service (PaaS) that supports multiple developer frameworks and an ecosystem of application services. Cloud Foundry facilitates the development and scaling of various applications. Cloud Foundry is available from Pivotal Software, Inc., which is located in Palo Alto, Calif.

Furthermore, and as shown in FIG. 1, the asset cloud computing system 104 includes an asset module 120, an analytics module 122, a data acquisition module 124, a data security module 126, and an operations module 128. Each of the modules 120-128 includes or uses a dedicated circuit, or instructions for operating a general purpose processor circuit, to perform the respective functions. In an example, the modules 120-128 are communicatively coupled in the asset cloud computing system 104 such that information from one module can be shared with another. The modules 120-128 may be co-located at a designated datacenter or other facility, or the modules 120-128 may be distributed across multiple different locations.

The asset cloud computing system 104 may be accessible and/or provide information to one or more industrial applications and/or data centers 132-138. For example, the cloud computing system 104 may provide information to one or more devices in the energy industry 132, one or more devices in the healthcare industry 134, one or more devices in the transportation industry 136, and/or one or devices that are connected as an IoT for industry 138. In this manner, the asset cloud computing system 104 becomes a distribution center for various industry devices 132-138 such that any one device may access the asset cloud computing system 104 for information about one or more assets in the asset community 106.

Furthermore, and in one embodiment, the AMP 102 is communicatively coupled with an interface device 130. The interface device 130 may be configured for data communication with one or more of the IIoT machine 108, the communication gateway 114, or the asset cloud computing system 104. The interface device 130 may be used to monitor or control one or more assets of the asset community 106. For example, and in one embodiment, information about the asset community 106 is presented to an operator at the interface device 130. The information about the asset community 106 may include, but is not limited to, information from the IIoT machine 108, information from the asset cloud computing system 104, information from the enterprise computing system 112, or combinations thereof. In one embodiment, the information from the asset cloud computing system 104 includes information about the asset community 106 in the context of multiple other similar or dissimilar assets, and the interface device 130 may include options for optimizing one or more members of the asset community 106 based on analytics performed at the asset cloud computing system 104.

One or more of the assets of the asset community 106 may be configurable by way of one or more parameters being updated by the interface device 130. For example, where an asset 110 is a wind turbine, an operator of the interface device 130 may request that a parameter for the wind turbine 110 be updated, and parameter update is pushed to the wind turbine 110 via one or more of the devices of the AMP 102, such as the asset cloud computing system 104, the communication gateway 114, and the IIoT machine 108, or combinations thereof.

Further still, the interface device 130 may communicate with the enterprise computing system 112 to provide enterprise-wide data about the asset community 106 in the context of other business or process data. For example, choices with respect to asset optimization can be presented to an operator in the context of available or forecasted raw material supplies or fuel costs. In an example, choices with respect to asset optimization can be presented to an operator in the context of a process flow to identify how efficiency gains or losses at one asset can impact other assets. In an example, one or more choices described herein as being presented to a user or operator can alternatively be made automatically by a processor circuit according to earlier-specified or programmed operational parameters. In an example, the processor circuit can be located at one or more of the interface device 130, the asset cloud computing system 104, the enterprise computing system 112, or elsewhere.

In one embodiment, the asset community 106 includes one or more wind turbines as assets, such as the wind turbine 110. A wind turbine is a non-limiting example of a type of industrial asset that can be a part of, or in data communication with, the AMP 102.

The asset community 106 may include assets from different manufacturers or vintages. The various assets (e.g., wind turbines, generators, solar panels, hydroelectric turbines, MRI scanners, buses, railcars, etc.) of the asset community 106 can belong to one or more different asset communities, and the asset communities can be located locally or remotely from one another. For example, the members of the asset community 106 can be co-located within a single community (e.g., a wind farm), or the members can be geographically distributed across multiple different communities (e.g., one or more geographically disparate wind farms). Furthermore, the one or more assets of the asset community 106 may be in use (or non-use) under similar or dissimilar environmental conditions, or may have one or more other common or distinguishing characteristics.

The asset community 106 is also communicatively coupled to the asset cloud computing system 104. In one embodiment, the AMP 102 includes a communication gateway 114 that communicatively couples the asset community 106 to the asset cloud computing system 104. The communication gateway 114 may further couple the asset cloud computing system 104 to one or more other assets and/or asset communities, to the enterprise computing system 112, or to one or more other devices. The AMP 102 thus represents a scalable industrial solution that extends from a physical or virtual asset (e.g., the industrial asset 110) to a remote asset cloud computing system 104. The asset cloud computing system 104 optionally includes a local, system, enterprise, or global computing infrastructure that can be optimized for industrial data workloads, secure data communication, and compliance with regulatory requirements.

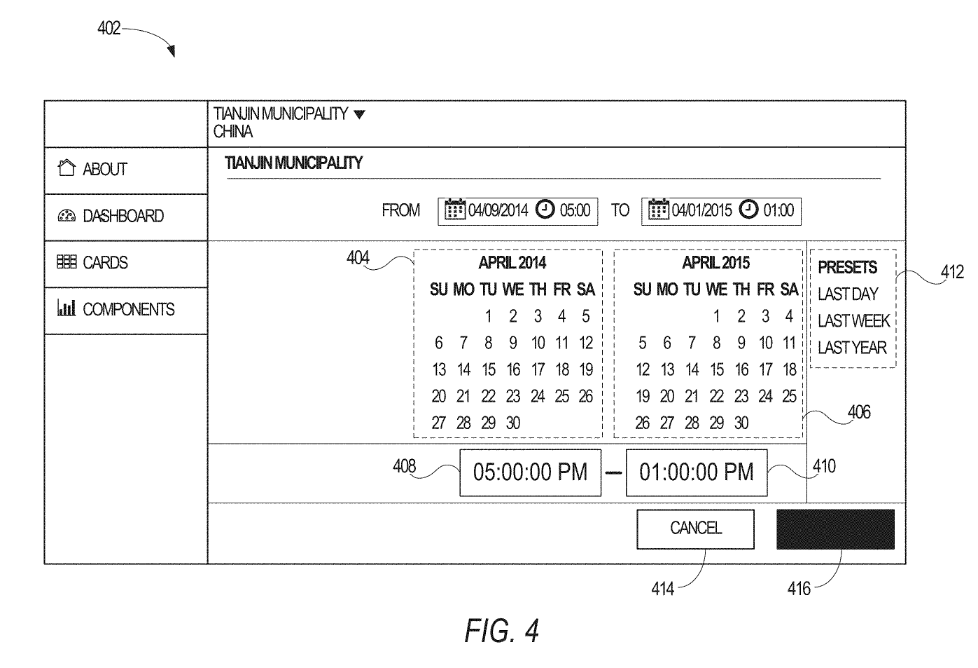

The asset cloud computing system 104 is configured to collect information and/or metrics about one or more assets and/or asset communities 106. In one embodiment, the information from the asset 110, about the asset 110, or sensed by the asset 110 is communicated from the asset 110 to the data acquisition module 124 in the asset cloud computing system 104. In one embodiment, an external sensor, such as a temperature sensor, gyroscope, infrared sensor, accelerometer, etc., is configured to sense information about a function of the asset 110, or to sense information about an environmental condition at or near the asset 110. The external sensor may be further configured for data communication with the communication gateway 114 (e.g., via one or more wired and/or wireless transmission mediums) and the data acquisition module 124. In one embodiment, the asset cloud computing system 104 is configured to use the sensor information in its analysis of one or more assets, such as using the analytics module 122. As discussed below with reference to FIGS. 4-8, a user may use a client device, such as the interface device 130, to request this monitored data for display on the interface device 130.

An operational model for the asset 110 may be employed by the asset cloud computing system 104. In one embodiment, the asset cloud computing system 104 invokes the asset module 120 to retrieve the operational model for the asset 110. The operational model may be stored in one or more locations, such as in the asset cloud computing system 104 and/or the enterprise computing system 112.

In addition, the asset cloud computing system 104 is configured to use the analytics module 122 to apply information received about the asset 110 or its operating conditions (e.g., received via the communication gateway 114) to or with the retrieved operational model. Using a result from the analytics module 122, the operational model may be updated, such as for subsequent use in optimizing the asset 110 or one or more other assets, such as one or more assets in the same or different asset community. In one embodiment, information and/or metrics about the asset 110 is used by the asset cloud computing system 104 to inform selection of an operating parameter for a remotely located asset that belongs to a different second asset community.

The IIoT machine 108 is configured to communicate with the asset community 106 and/or the asset cloud computing system 104. Accordingly, in one embodiment, the IIoT machine 108 includes a software layer configured for communication with the asset community 106 and the asset cloud computing system 104. Further still, the IIoT machine 108 may be configured to execute an application locally at the asset 110 of the asset community 106. The IIoT machine 108 may be configured for use with or installed on gateways, industrial controllers, sensors, and other components.

In one embodiment, the IIoT machine 108 is implemented as a software stack that can be embedded into hardware devices such as industrial control systems or network gateways. The software stack may include its own software development kit (SDK). The SDK includes functions that enable developers to leverage the core features described below.

One responsibility of the IIoT machine 108 is to provide secure, bi-directional cloud connectivity to, and management of, industrial assets, while also enabling applications (analytical and operational services) at the edge of the IIoT. The latter permits the delivery of near-real-time processing in controlled environments. Thus, the IIoT machine 108 connects to the asset cloud computing system 104 and communicates with the various modules 120-128. This allows other computing devices, such as the interface device 130, running user interfaces/mobile applications to perform various analyses of either the industrial asset 110 or other assets within the asset community 106.

In addition to the foregoing, the IIoT machine 108 also provides security, authentication, and governance services for endpoint devices. This allows security profiles to be audited and managed centrally across devices, ensuring that assets are connected, controlled, and managed in a safe and secure manner, and that critical data is protected.

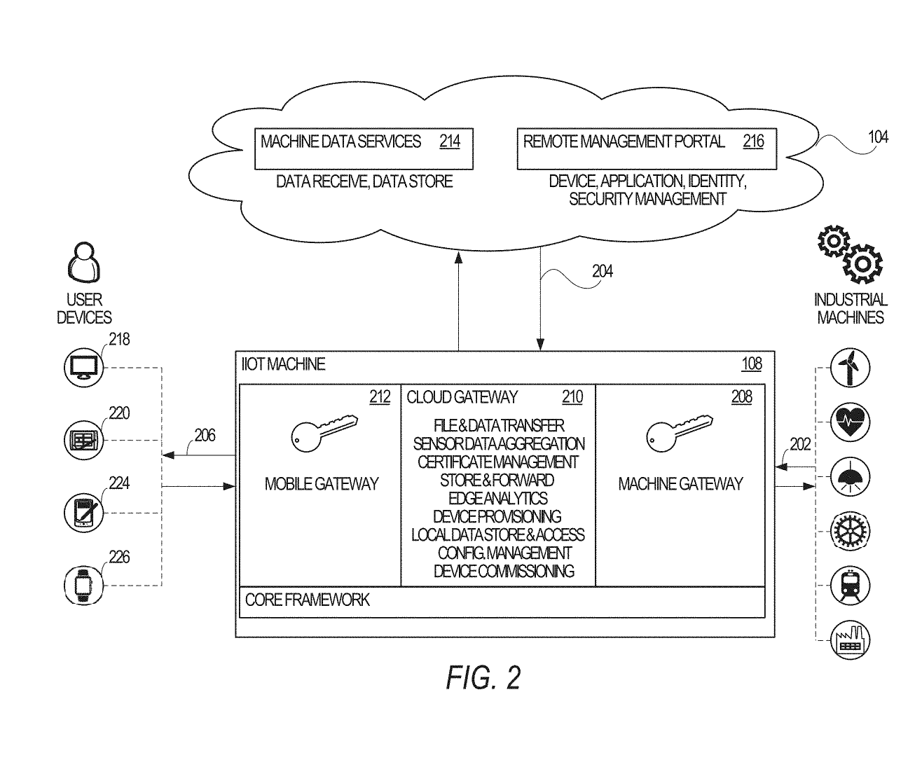

In order to meet requirements for industrial connectivity, the IIoT machine 108 can support gateway solutions that connect multiple edge components via various industry standard protocols. FIG. 2 is a block diagram illustrating different edge connectivity options that an IIoT machine 108 provides, in accordance with an example embodiment. There are generally three types of edge connectivity options that an IIoT machine 108 provides: machine gateway (M2M) 202, cloud gateway (M2DC) 204, and mobile gateway (M2H) 206.

Many assets may already support connectivity through industrial protocols such as Open Platform Communication (OPC)-UA or ModBus. A machine gateway component 208 may provide an extensible plug-in framework that enables connectivity to assets via M2M 202 based on these common industrial protocols.

A cloud gateway component 210 connects an IIoT machine 108 to the asset cloud computing system 104 via M2DC. As discussed above, the asset cloud computing system 104 provides various machine data services 214 and a remote management portal 216 for managing various connected industrial assets and/or the IIoT machine 108.

In one embodiment, the IIoT machine 108 is configured with a mobile gateway component 212 that facilitates bypassing asset cloud computing system 104 and establishing a direct connection to an industrial asset (e.g., the industrial asset 110). In some circumstances, the direct connection is used in maintenance scenarios. When service technicians are deployed to maintain or repair machines, they can connect directly from their machine (e.g., interface device 130) to understand the asset's operating conditions and perform troubleshooting. In certain industrial environments, where connectivity can be challenging, the ability to bypass the cloud and create this direct connection to the asset 110 is helpful and technically beneficial.

The IIoT machine 108 may be deployed in various different ways. For example, the IIoT machine 108 may be deployed on the communication gateway 114, on various controllers communicatively coupled to one or more assets, or on sensors that monitor the industrial assets or the asset community 106. Where the IIoT machine 108 is deployed directly on one or more machine controllers, this deployment decouples the machine software from the machine hardware, allowing connectivity, upgradability, cross-compatibility, remote access, and remote control. It also upgrades industrial and commercial assets, which have traditionally operated standalone or in very isolated networks, to be connected directly to the asset cloud computing system 104 for data collection and live analytics.

Where the IIoT machine 108 is deployed on one or more sensors that collect and/or monitor data from one or more of the industrial assets, the sensors collect asset and environmental data, which is then communicated to the asset cloud computing system 104 for storage, analysis, and visualization.

Customers or other users of the asset cloud computing system 104 may create applications to operate, or reside on, the asset cloud computing system 104. While the applications reside on, or are executed by, the asset cloud computing system 104, these applications may leverage monitored data (or other metrics) gathered by IIoT machines (e.g., IIoT machine 108) that are in communication with one or more industrial assets or asset communities 106. In summary, the asset cloud computing system 104 contributes to the IIoT by providing a scalable cloud infrastructure that serves as a basis for platform-as-a-service (PaaS), which is what developers use to create Industrial Internet applications for use in the IIoT.

In one embodiment, and as shown in FIG. 2, various user devices 218-226 communicate with the IIoT machine 108 via the mobile gateway component 212. However, in alternative embodiments, the user devices 218-226 communicate with the IIoT machine 108 via the asset cloud computing system 104, such as through one or more of the modules 120-128. Where the user devices 218-226 access data and/or services provided by the asset cloud computing system 104 and/or IIoT machine 108, the user devices 218-226 are considered client devices.

The user devices 218-226 may comprise, but are not limited to, a mobile phone, desktop computers, laptops, portable digital assistants (PDAs), smart phones, tablets, ultra-books, netbooks, wearable devices (e.g., smartwatch or assisted-vision devices), multi-processor systems, microprocessor-based or programmable consumer electronics, or any other communication devices that a user may utilize to access the asset cloud computing system 104 or the IIoT machine 108. In some embodiments, the user devices 218-226 include a display module (not shown) to display information (e.g., in the form of user interfaces). In further embodiments, the user devices 218-226 include one or more of touch screens, accelerometers, gyroscopes, cameras, microphones, global positioning system (GPS) devices, and so forth.

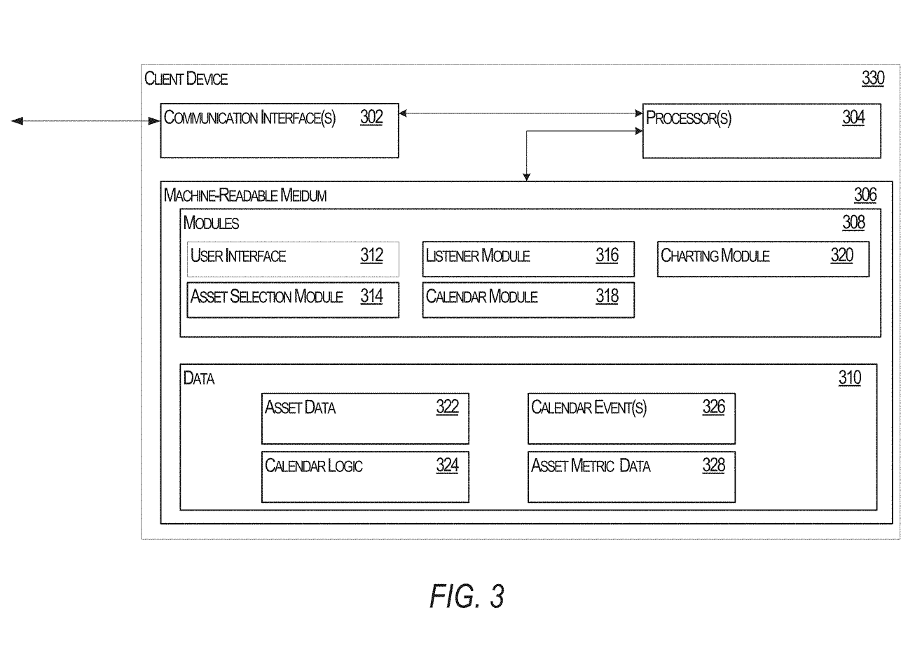

In one embodiment, a user uses one or more of the user devices 218-226 to retrieve and/or view monitored data from one or more of the assets of the asset community 106. FIG. 3 illustrates a client device 330 of FIG. 2, according to an example embodiment. In one embodiment, the client device 330 includes one or more processor(s) 304, one or more communication interface(s) 302, and a machine-readable medium 306 that stores computer-executable instructions for one or more modules 308 and data 310 used to support one or more functionalities of the modules 308.

The various functional components of the client device 330 may reside on a single device or may be distributed across several computers in various arrangements. The various components of the client device 330, furthermore, may access one or more other components of the AMP 102 (e.g., one or more of the module 120-128, the IIoT machine 108, the communication gateway 114, or any of data 310), and each of the various components of the client device 330 may be in communication with one another. Further, while the components of FIG. 3 are discussed in the singular sense, it will be appreciated that, in other embodiments, multiple instances of the components may be employed.

The one or more processors 304 may be any type of commercially available processor, such as processors available from the Intel Corporation, Advanced Micro Devices, Texas Instruments, or other such processors. Further still, the one or more processors 304 may include one or more special-purpose processors, such as a field-programmable gate array (FPGA) or an application specific integrated circuit (ASIC). The one or more processors 304 may also include programmable logic or circuitry that is temporarily configured by software to perform certain operations. Thus, once configured by such software, the one or more processors 304 become specific machines (or specific components of a machine) uniquely tailored to perform the configured functions and are no longer general-purpose processors.

The one or more communication interfaces 302 are configured to facilitate communications between the client device 330, the asset cloud computing system 104, the communication gateway 114, the enterprise computing system 112, and/or IIoT machine 108. The one or more communication interfaces 302 may include one or more wired interfaces (e.g., an Ethernet interface, Universal Serial Bus (USB) interface, a Thunderbolt® interface, etc.), one or more wireless interfaces (e.g., an IEEE 802.11b/g/n interface, a Bluetooth® interface, an IEEE 802.16 interface, etc.), or combinations of such wired and wireless interfaces.

The machine-readable medium 306 includes various modules 308 and data 310 for implementing the client device 330. The machine-readable medium 306 includes one or more devices configured to store instructions and data 310 temporarily or permanently and may include, but not be limited to, random-access memory (RAM), read-only memory (ROM), buffer memory, flash memory, optical media, magnetic media, cache memory, other types of storage (e.g., erasable programmable read-only memory (EEPROM) and/or any suitable combination thereof. The term “machine-readable medium” should be taken to include a single medium or multiple media (e.g., a centralized or distributed database, or associated caches and servers) able to store the modules 308 and the data 310. Accordingly, the machine-readable medium 306 may be implemented as a single storage apparatus or device, or, alternatively and/or additionally, as “cloud-based” storage systems or storage networks that include multiple storage apparatus or devices. As shown in FIG. 3, the machine-readable medium 306 excludes signals per se.

In one embodiment, the modules 308 are written in a computer-programming and/or scripting language. Examples of such languages include, but are not limited to, C, C++, C#, Java, JavaScript, Perl, Python, or any other computer programming and/or scripting language now known or later developed. The modules 308 may also be implemented via one or more computer-programming and/or scripting language libraries, such as Polymer.

With reference to FIG. 3, the modules 308 of the client device 330 include, but are not limited to, a user interface module 312, an asset selection module 314, a listener module 316, a calendar module 318, and a charting module 320. The data 310 referenced and used by the modules 308 include asset data 322, calendar logic 324, one or more calendar event(s) 326, and asset metric data 328. The client device 330 may further include one or more output devices (not shown) communicatively coupled to the processor(s) 304 which may include, but are not limited to, touch-screen displays, liquid crystal displays (LCDs), light-emitting diode (LED) displays, one or more speakers, vibrational controllers, force feedback devices, and other such output devices or combination of output devices.

The user interface module 312 is configured to provide access to, and interactions with, the client device 330. In one embodiment, the user interface module 312 provides one or more graphical user interfaces, which may be provided using the Hypertext Transfer Protocol (HTTP). The graphical user interfaces are displayable by the client device 330 and accept input from the user for interacting with the client device 330. Further still, the user interface module 312 may be configured to provide such interfaces to one or more clients displayable by the client device 330, such as a web client, one or more client applications, or a programmatic client. By interacting with the user interface module 312, the user can instruct the client device 330 to display information about a selected industrial asset. Further still, the user interface module 312 is configured to generate a display of various graphical elements used by one or more of the modules 308, such as graphical elements leveraged by the asset selection module 314, the calendar module 318, or the charting module 320.

With reference to FIG. 1, the asset selection module 314 is configured to receive a selection of an industrial asset being monitored by the IIoT machine 108. In one embodiment, the asset selection module 314 communicates with the IIoT machine 108 to obtain a list of industrial assets that are being monitored by the IIoT machine 108. For example, the asset selection module 314 may obtain a list of the industrial assets within the asset community 106. Industrial assets that are accessible using the client device 330 are stored as asset data 322, which is leveraged by the asset selection module 314 in providing asset selection options via the user interface module 312. In one embodiment, the asset selection module 314 operates with the user interface module 312 to display a selectable menu, such as a drop-down menu, of selectable industrial assets. In an alternative embodiment, the asset selection module 314 displays groups of industrial asset that may be selected by the user, such as the asset community 106. After making a selection of an industrial asset or asset community, the user may then invoke the calendar module 318 to select a time frame of monitored data for the selected industrial asset or asset community.

The calendar module 318 is configured to display a graphical Web component having one or more graphical calendars that are selectable by the user of the client device 330 for selecting a time frame corresponding to the monitored data that the user would like to view. Accordingly, FIG. 4 illustrates a graphical user interface 402 for interacting with the calendar Web component, according to an example embodiment. As shown in FIG. 4, the calendar Web component displays a first graphical calendar 404 and a second graphical calendar 406. Each of the graphical calendars 404-406 include selectable calendar dates that the user may select to indicate the desired time frame of the monitored data. In addition, the calendar Web component includes a first input element 408 and a second input element 410 that accept as input a specific time in which to start and/or end the time frame corresponding to the selected dates from the first graphical calendar 404 and the second graphical calendar 406. In one embodiment, the input elements 408-410 are text fields in which the user may type the beginning and/or end time. The input elements 408-410 may also be implemented as other types of input elements such as drop-down menus, radio buttons, scrollable menus, or any other type of input element or combination of input elements.

In addition, the calendar Web component includes a preset menu 412 having selectable preset options that select a preconfigured timeframe in response to being selected by the user. In one embodiment, when a preset option is selected, the calendar Web component invokes a current time function to obtain the current time (e.g., such as the current day, current week, and/or current year) and selects the dates from the first graphical calendar 404 and/or second graphical calendar 406 based on the selected preset option and the obtained current time. As shown in FIG. 4, example preset options may include a “LAST DAY,” “LAST WEEK,” and a “LAST YEAR” options. However, in alternative embodiments, other preset options may also be displayed in the preset menu 412. For example, an administrator or other operator of the asset cloud computing system 104 may configure additional preset options to be displayed in the preset menu 412.

The calendar Web component further displays input elements 414-416 for confirming or canceling the current selected timeframe. Accordingly, when the input element 414 is selected the current timeframe selection is canceled and when the input element 416 is selected the current timeframe selection is submitted or applied.

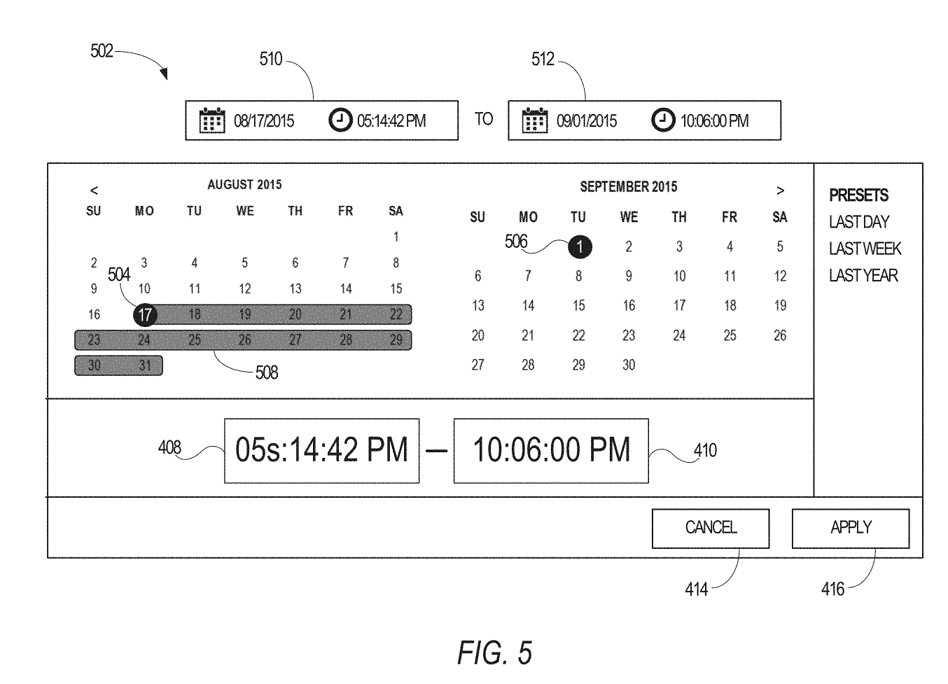

When one or more dates are selected using the first graphical calendar 404 and the second graphical calendar 406, the calendar Web component displays graphical indications to indicate which dates have been selected. FIG. 5 illustrates the effect of selecting dates on a displayed graphical calendar, according to an example embodiment. As shown in FIG. 5, a starting date has a first graphical indication 504, an ending date has a second graphical indication 506, and the range of dates between the starting date and the ending date have a third graphical indication 508. In addition, the calendar Web component includes a starting date display element 510 and an ending date display element 512 that each indicate the starting date and time and ending date and time, respectively. The starting date display element 510 is updated in response to the user selecting a starting date and the ending date display element 512 is updated in response to the user selecting an ending date.

In one embodiment, the graphical indications are implemented as changes in state to the selectable dates of the first graphical calendar 404 and the second graphical calendar 406. Table 1, below, indicates the various states that a selectable date may take on depending on whether the date has been selected, pressed, or a mouse cursor is hovering over the selectable date. In this context, “selected” refers to the instance where the date has been selected but the user is not depressing a mouse button or other input device used to select the date. Accordingly, “pressed” refers to the instance where the date has been selected and the user is depressing a mouse button or other input device at the time of selection. In addition, Table 1 identifies the graphical indication that a selectable date may acquire and lists a color's hexadecimal representation in order to accurately convey the color applied to the selectable date.

| State | Graphical Indication |
|---|---|
| Normal | Fill: None |
| | Text: #000000 |
| | Shadow: None |
| Disabled | Fill: None |
| | Text: # D1D0D8 |
| | Shadow: None |
| Hover | Fill: #3399FF |
| | Text: #FFFFFF |
| | Shadow: None |
| Pressed | Fill: #2B5EA2 |
| | Text: #FFFFFF |
| | Shadow: None |
| Selected | Fill: #0A9EC1 |
| | Text: #FFFFFF |
| | Shadow: None |
| Selected Hover | Fill: #0986A4 |
| | Text: #FFFFFF |
| | Shadow: None |
| Selected Hover Pressed | Fill: #086E87 |
| | Text: #FFFFFF |
| | Shadow: None |

By having multiple different states, where each state is associated with a particular color scheme, a user can quickly see which dates are the starting and ending dates, and which dates are the range of dates that fall between. In FIG. 5, the first graphical indication 504 and the second graphical indication 506 may each correspond to the state of “SELECTED” and have the corresponding coloring applied.

As discussed above, the calendar Web component supports the input of a specific starting time and a specific ending time for the time frame being selected by the user. However, there may be instances where the user does not input a valid time. Accordingly, the calendar Web component includes logic, represented by calendar logic 324 of FIG. 3, which validates that a provided time is a valid time. In one embodiment, the calendar logic 324 includes a regular expression which validates that a time input using the first input element 408 or the second input element 410 is a valid time. As an example, the regular expression may be written as: ̂(([0-1]?[0-9])([2][0-3])):([0-5]?[0-9])(:([0-5]?[0-9]))?$. In this example, the foregoing regular expression matches time written in a 24-hour format with optional seconds such as “12:15,” “10:26:59,” or “22:01:15”.

Where the input time is not valid (e.g., such as by including an extraneous or non-matching character), the calendar Web component is configured to prevent the user from continuing with the invalid time input. As shown in FIG. 5, the first input element 408 includes the non-matching character “s.” In this example, the calendar Web component has disabled the input element 416 by changing its state to a “DISABLED” state, which prevents the user from continuing with the invalid time input. Once the invalid time is corrected (e.g., such as by removing the non-matching character “s”), the calendar Web component is configured to re-enable the input element 416.

In addition to the logic for determining whether an invalid time has been entered, the calendar logic 324 also includes logic for determining whether a selected date is an ending date or starting date. Conventionally, a user selects a starting date first and an ending date second. However, there may be instances where the user changes his or her mind and desires to select the ending date first and the starting date second.

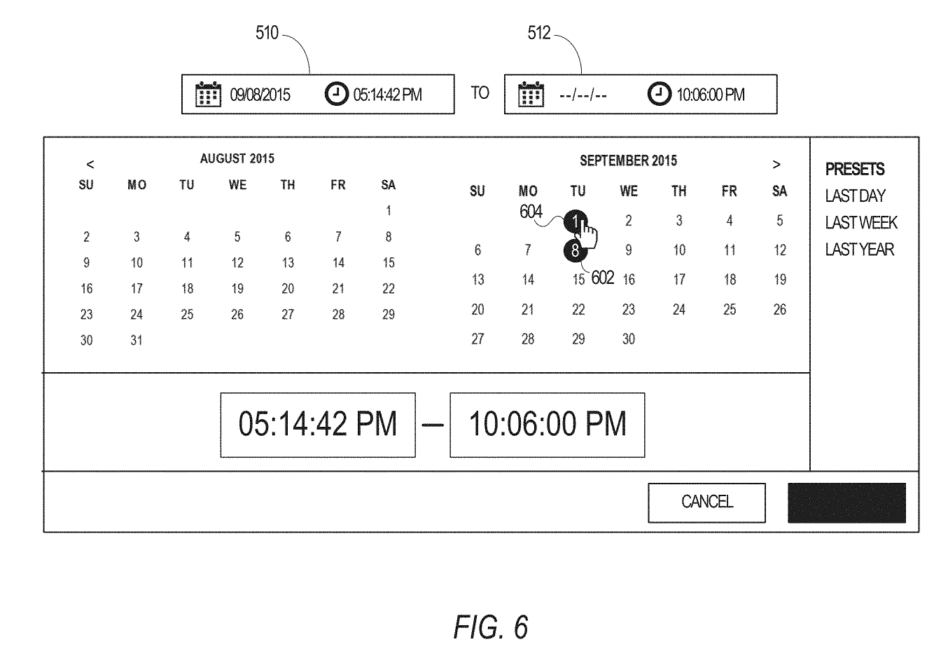

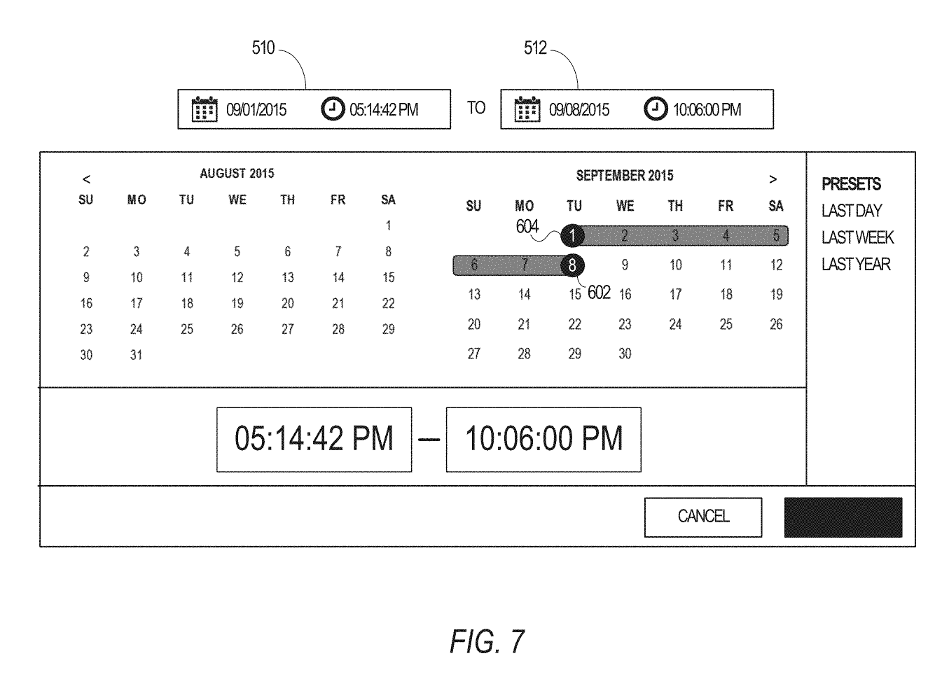

FIGS. 6-7 illustrate the effect of selecting an ending date first and a starting date second on the displayed graphical calendars 404-406, according to an example embodiment. In these instances, and in one embodiment, the calendar logic 324 first determines whether the user has selected a first date, and whether the second date being selected occurs later in time than the first date. As shown in FIG. 6, the user has selected an ending date 602 first and is in the process of selecting a starting date 604 second. However, the calendar logic 324 is not yet aware of the user's second selection, therefore, the starting date display element 510 displays the user's intended ending date (e.g., the first selected date 602) as the starting date 604.

Upon selecting the second date 604, the calendar logic 324 is configured to determine whether the second date 604 occurs later (or earlier) in time than the first selected date 602 (e.g., the ending date). FIG. 7 illustrates the calendar logic 324 having determined that the second selected date 604 occurs earlier in time than the first selected date 602, according to an example embodiment. In addition to establishing the second selected date 604 as the starting date 604, the calendar logic 324 also establishes the first selected date 602 as the ending date. Accordingly, the states of the selected dates 602-604 are updated and the corresponding graphical indication is applied. Similarly, the graphical indication is applied to the intervening dates between the first selected date 602 and the second selected date 604. Finally, the calendar logic 324 also updates the starting date display element 510 in the ending date display element 512 to accurately represent which date is the starting date 604 and which date is the ending date 602. In the example shown in FIG. 7, the starting date display element 510 has been updated with the date of the second selected date 604, and the ending date display element 512 has been updated with the date of the first selected date 602. In this manner, the calendar Web component supports the selection of a time frame regardless of whether the starting date 604 is selected first or second and whether the ending date 602 is selected first or second.

Referring back to FIG. 4, once the user is satisfied with the selected timeframe as shown in the first graphical calendar 404 and/or the second graphical calendar 406, the user then selects the input element 416 to confirm the selected timeframe. As discussed above, the calendar module 318 may implement the calendar Web component using the Polymer library. In Polymer, a Web component is treated as a self-contained unit, where actions performed by the self-contained unit are broadcast as events for consumption by other Web components. In this context, the broadcast may be local to the client device 330. A listener module 316 may be implemented by one or more of the Web components instantiated by the client device 330, where the listener module 316 listens for events being broadcast by the various instantiated Web components.

Accordingly, in one embodiment, when the user selects the input element 416, the calendar module 318 broadcasts an event that includes an event identifier that identifies the type of event being broadcasted along with timeframe parameters whose values correspond to the timeframe selected by the user. The event, and its corresponding parameters, may be stored as calendar events 326 and the data 310. In this manner, any Web components listening for the event broadcast by the calendar module 318 may consume the broadcasted event for their own purpose.

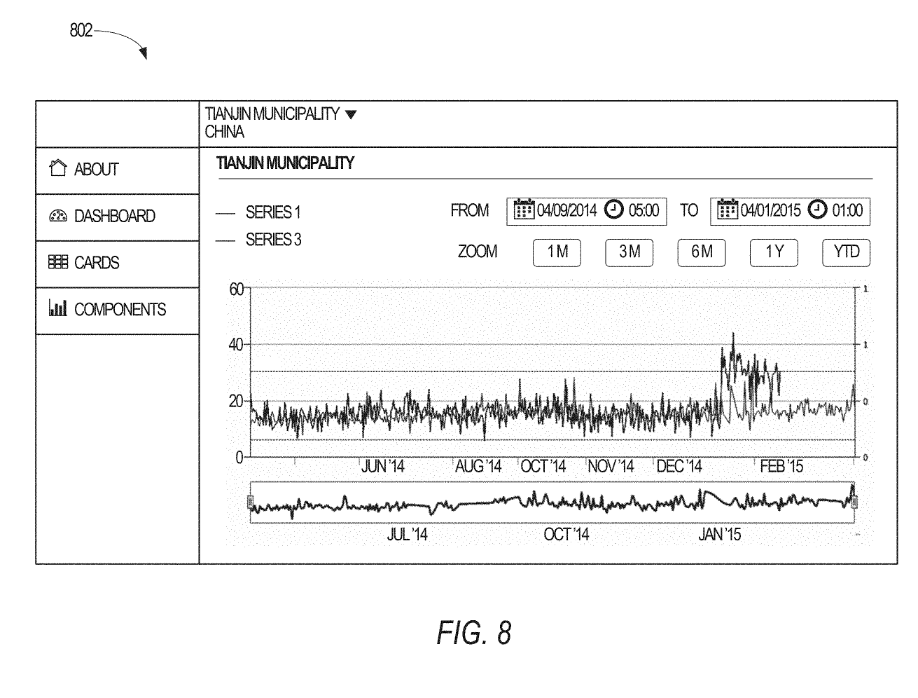

The charting module 320 is configured to consume the event broadcasted by the calendar module 318. FIG. 8 illustrates a graphical user interface 802 displaying monitored data in response to a broadcasted calendar event 326, according to an example embodiment. In one embodiment, when the calendar module 318 broadcasts a calendar event 326, the charting module 320 requests monitored data from the IIoT machine 108 recorded during the timeframe identified by the broadcast calendar event 326 from the industrial asset selected using the asset selection module 314. The type of data requested by the charting module 320 may be based on one or more selections made using the asset selection module 314 and/or the calendar module 318. Examples of data that may be requested by the charting module 320 may include operational data, performance data, temperature or other atmospheric data, or any other type or combination of data monitored by the IIoT machine 108 for a given industrial asset or asset community.

When the charting module 320 receives the requested data from the IIoT machine 108, the monitored data is stored as the asset metric data 328 and is displayed within the graphical user interface 802. In alternative embodiments, the charting module 320 may communicate with other components of the AMP 102 such as the asset cloud computing system 104, the enterprise computing system 112, and/or the selected industrial asset (e.g., industrial asset 110).

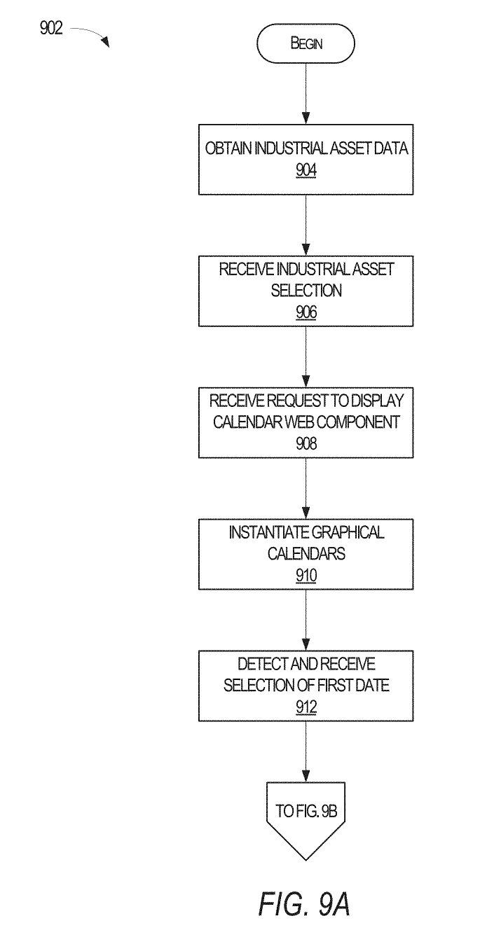

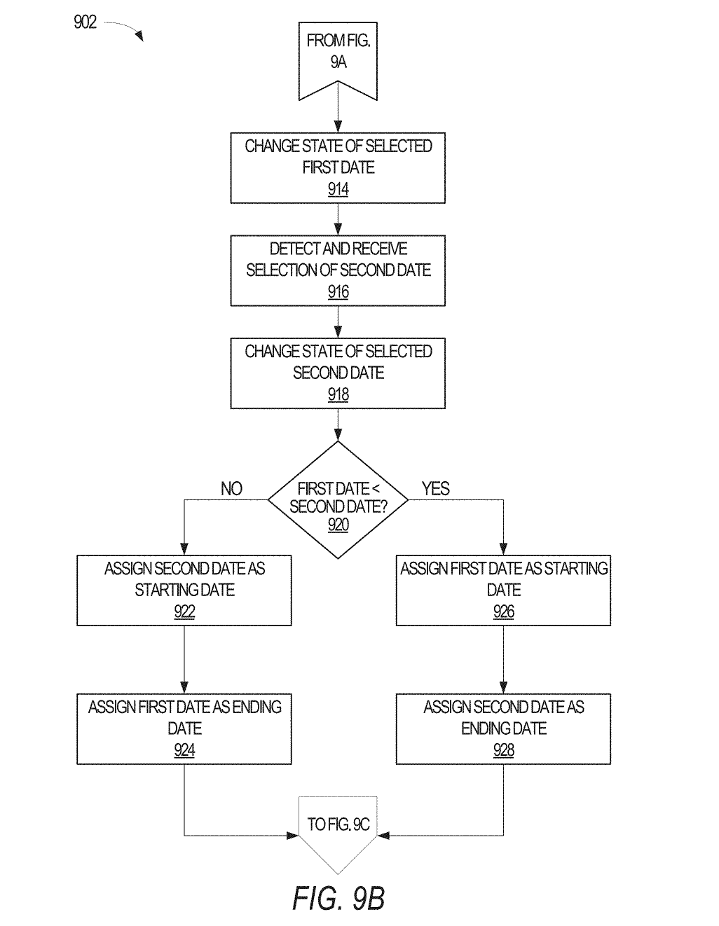

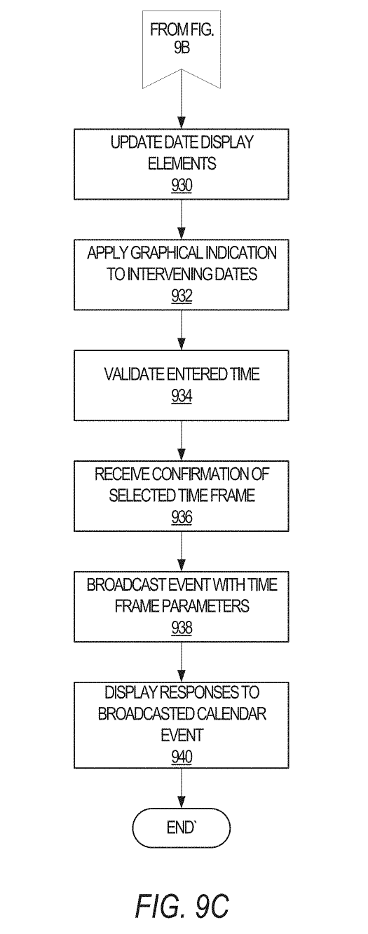

FIGS. 9A-9C illustrate a method, in accordance with an example embodiment, for requesting monitored data using a calendar web component. The method 902 may be implemented by one or more of the modules 308 and data 310 of the client device 330 and is discussed by way of reference thereto.

With reference to FIG. 9A and FIG. 3, the asset selection module 314 initially obtains asset data 322 or industrial assets that are selectable by the user of the client device 330 (Operation 904). The asset selection module 314 then receives the user's selection of an industrial asset (Operation 906). The client device 330 then receives a user's request to display a calendar web component implemented by the calendar module 318 (Operation 908). In one embodiment, the user's request may be received via a graphical user interface 802 instantiated by the user interface module 312.

In response, and as discussed above with reference to FIG. 4, the calendar module 318 instantiates a calendar web component having one or more graphical calendars 404-406 (Operation 910). The calendar module 318 then receives the user's selection of a first date from a selectable date of the first graphical calendar 404 or the second graphical calendar 406 (Operation 912).

Continuing to FIG. 9B, the calendar module 318 then changes the displayed state of the selected date (Operation 914). As discussed previously with regard to Table 1, a selected date may be changed to one or more states, where each state is associated with graphical changes to the selected date. The calendar module 318 then detects and receives the selection of a second date 604 from a selectable date of the first graphical calendar 404 the second graphical calendar 406 (Operation 916).

As with the first selected date, the second selected date may also have a change in state, which includes the application of a graphical indication to indicate that the second date 604 has been selected (Operation 918). The calendar module 318 then determines whether the first selected date is less than the second selected date (Operation 920). In additional or alternative embodiments, the calendar module 318 determines whether the second selected date is less than the first selected date. Where this determination is made in the affirmative (e.g., “No” branch of Operation 920), the calendar module 318 assigns the second selected date as the starting date 604 for a defined timeframe (Operation 922) and the first selected date as the ending date 602 for the defined timeframe (Operation 924). Conversely, where this determination is made in the negative (e.g., “Yes” branch of Operation 920), the calendar module 318 assigns the first selected date as the starting date 604 for the defined timeframe (Operation 926) and the second selected date as the ending date 602 for the defined timeframe (Operation 928).

Referring to FIG. 9C, the calendar module 318 then updates one or more of the date display elements 510-512 as shown in FIG. 5 (Operation 930). In addition, the calendar module 318 applies a graphical indication to the intervening dates between the determined starting date 604 and the determined ending date 602 (Operation 932). As discussed above, the graphical indication applied to the intervening dates helps the user of the client device 330 readily determine the actual duration of the defined timeframe.

Furthermore, and with reference to FIG. 4, the calendar module 318 then validates any times entered into the input element 408 and/or input element 410 (Operation 934). In one embodiment, and as discussed previously, the validation may be performed via a regular expression defined in the calendar logic 324. Moreover, while the validation is being described as occurring after the application of the graphical indication to the intervening dates, one of ordinary skill in the art will appreciate that such validation may occur at any point within the method 902 of FIGS. 9A-9C. Thus, the validation of the entered times may be performed before or after the user has selected one or more of the starting and ending dates 602. As also discussed above, should one or both of the entered times be determined as being invalid, the calendar module 318 may prevent the user from submitting the defined timeframe (e.g., such as by disabling the input element 416).

The calendar module 318 then receives confirmation of the timeframe defined by the starting date 604, ending date 602, starting time, and ending time (Operation 936). As discussed above, such confirmation may be provided by the user selecting an input element 416. Having received the confirmation, the calendar module 318 then broadcasts calendar events 326 with the defined timeframe parameters (Operation 938). As explained previously, one or more other web components instantiated by the client device 330 may listen for the broadcast calendar event 326 via a listener module 316. In one embodiment, a charting module 320 consumes the broadcast calendar event 326 and requests monitored data for a selected industrial asset from the IIoT machine 108 having recorded data within the defined timeframe. Accordingly, and as discussed with reference to FIG. 8, the charting module 320 displays a chart having the monitored data recorded within the timeframe defined via the calendar web component (Operation 940). One of ordinary skill in the art will appreciate that charting module 320 is one example of a component that may use the broadcast calendar event 326 and that the client device 330 may instantiate other components that also use the broadcast calendar event 326. Thus, multiple components may act simultaneously in response to the broadcast calendar event 326.

In this manner, this disclosure provides a system and method for managing an industrial asset and obtaining monitored data for the industrial asset recorded during a defined timeframe. The disclosed calendar web component facilitates the construction of the defined timeframe such that a user can visually see and distinguish those dates are included within the defined timeframe. Furthermore, as the disclosed calendar web component reports the entry of specific times, the user can specify with a high degree of granularity the starting and ending points of the defined timeframe. Such granularity can be important in instances where changes in monitored data occur with a relatively high degree of frequency (e.g., within seconds or milliseconds). The granularity provided by the disclosed calendar web component further allows a user to pinpoint the exact date and/or time when a problem or deviation in the monitored data may have occurred with regard to a specific industrial asset.

### Modules, Components, and Logic

Certain embodiments are described herein as including logic or a number of components, modules, or mechanisms. Modules may constitute either software modules (e.g., code embodied on a machine-readable medium 306) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field-programmable gate array (FPGA) or an application specific integrated circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Machine and Software Architecture

The modules, methods, applications and so forth described in conjunction with FIGS. 1-9C are implemented in some embodiments in the context of a machine and an associated software architecture. The sections below describe a representative architecture that is suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things” while yet another combination produces a server computer for use within a cloud computing architecture. Not all combinations of such software and hardware architectures are presented here as those of skill in the art can readily understand how to implement the inventive subject matter in different contexts from the disclosure contained herein.

### Example Machine Architecture and Machine-Readable Medium

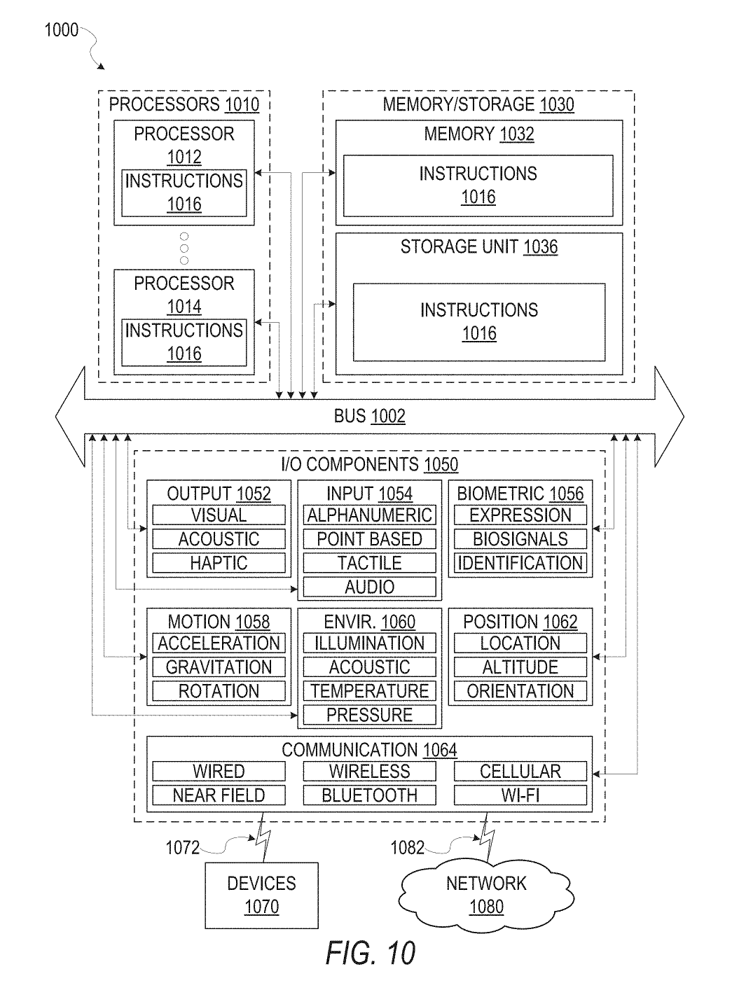

FIG. 10 is a block diagram illustrating components of a machine 1000, according to some example embodiments, able to read instructions from a machine-readable medium 306 (e.g., a machine-readable storage medium) and perform any one or more of the methodologies discussed herein. Specifically, FIG. 10 shows a diagrammatic representation of the machine 1000 in the example form of a computer system, within which instructions 1016 (e.g., software, a program, an application, an applet, an app, or other executable code) for causing the machine 1000 to perform any one or more of the methodologies discussed herein may be executed. For example, the instructions 1016 may cause the machine 1000 to execute the flow diagrams of FIGS. 9A-9C. Additionally, or alternatively, the instructions 1016 may implement one or more of the components of FIGS. 1-3. The instructions 1016 transform the general, non-programmed machine 1000 into a particular machine 1000 programmed to carry out the described and illustrated functions in the manner described. In alternative embodiments, the machine 1000 operates as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a personal computer (PC), a tablet computer, a laptop computer, a netbook, a personal digital assistant (PDA), or any machine capable of executing the instructions 1016, sequentially or otherwise, that specify actions to be taken by machine 1000. Further, while only a single machine 1000 is illustrated, the term “machine” shall also be taken to include a collection of machines 1000 that individually or jointly execute the instructions 1016 to perform any one or more of the methodologies discussed herein.

The machine 1000 may include processors 1010, memory/storage 1030, and I/O components 1050, which may be configured to communicate with each other such as via a bus 1002. In an example embodiment, the processors 1010 (e.g., a central processing unit (CPU), a reduced instruction set computing (RISC) processor, a complex instruction set computing (CISC) processor, a graphics processing unit (GPU), a digital signal processor (DSP), an application specific integrated circuit (ASIC), a radio-frequency integrated circuit (RFIC), another processor, or any suitable combination thereof) may include, for example, processor 1012 and processor 1014 that may execute the instructions 1016. The term “processor” is intended to include a multi-core processor 1010 that may comprise two or more independent processors 1010 (sometimes referred to as “cores”) that may execute instructions 1016 contemporaneously. Although FIG. 10 shows multiple processors 1010, the machine 1000 may include a single processor 1010 with a single core, a single processor 1010 with multiple cores (e.g., a multi-core processor), multiple processors 1010 with a single core, multiple processors 1010 with multiples cores, or any combination thereof.

The memory/storage 1030 may include a memory 1032, such as a main memory, or other memory storage, and a storage unit 1036, both accessible to the processors 1010 such as via the bus 1002. The storage unit 1036 and memory 1032 store the instructions 1016 embodying any one or more of the methodologies or functions described herein. The instructions 1016 may also reside, completely or partially, within the memory 1032, within the storage unit 1036, within at least one of the processors 1010 (e.g., within the processor's cache memory), or any suitable combination thereof, during execution thereof by the machine 1000. Accordingly, the memory 1032, the storage unit 1036, and the memory of processors 1010 are examples of machine-readable media.

As used herein, “machine-readable medium” means a device able to store instructions 1016 and data 310 temporarily or permanently and may include, but is not limited to, random-access memory (RAM), read-only memory (ROM), buffer memory, flash memory, optical media, magnetic media, cache memory, other types of storage (e.g., erasable programmable read-only memory (EEPROM)) and/or any suitable combination thereof. The term “machine-readable medium” should be taken to include a single medium or multiple media (e.g., a centralized or distributed database, or associated caches and servers) able to store instructions 1016. The term “machine-readable medium” shall also be taken to include any medium, or combination of multiple media, that is capable of storing instructions (e.g., instructions 1016) for execution by a machine (e.g., machine 1000), such that the instructions 1016, when executed by one or more processors of the machine 1000 (e.g., processors 1010), cause the machine 1000 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 1050 may include a wide variety of components to receive input, provide output, produce output, transmit information, exchange information, capture measurements, and so on. The specific I/O components 1050 that are included in a particular machine 1000 will depend on the type of machine 1000. For example, portable machines such as mobile phones will likely include a touch input device or other such input mechanisms, while a headless server machine will likely not include such a touch input device. It will be appreciated that the I/O components 1050 may include many other components that are not shown in FIG. 10. The I/O components 1050 are grouped according to functionality merely for simplifying the following discussion and the grouping is in no way limiting. In various example embodiments, the I/O components 1050 may include output components 1052 and input components 1054. The output components 1052 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1054 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 1050 may include biometric components 1056, motion components 1058, environmental components 1060, or position components 1062 among a wide array of other components. For example, the biometric components 1056 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1058 may include acceleration sensor components (e.g., accelerometer), gravitation sensor components, rotation sensor components (e.g., gyroscope), and so forth. The environmental components 1060 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1062 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1050 may include communication components 1064 operable to couple the machine 1000 to a network 1080 or devices 1070 via coupling 1082 and coupling 1072 respectively. For example, the communication components 1064 may include a network interface component or other suitable device to interface with the network 1080. In further examples, communication components 1064 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 1070 may be another machine or any of a wide variety of peripheral devices (e.g., a peripheral device coupled via a Universal Serial Bus (USB)).

Moreover, the communication components 1064 may detect identifiers or include components operable to detect identifiers. For example, the communication components 1064 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF416, Ultra Code, UCC RSS-2D bar code, and other optical codes), or acoustic detection components (e.g., microphones to identify tagged audio signals). In addition, a variety of information may be derived via the communication components 1064, such as location via Internet Protocol (IP) geo-location, location via Wi-Fi® signal triangulation, location via detecting a NFC beacon signal that may indicate a particular location, and so forth.

### Transmission Medium

In various example embodiments, one or more portions of the network 1080 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 1080 or a portion of the network 1080 may include a wireless or cellular network and the coupling 1082 may be a Code Division Multiple Access (CDMA) connection, a Global System for Mobile communications (GSM) connection, or other type of cellular or wireless coupling. In this example, the coupling 1082 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 1016 may be transmitted or received over the network 1080 using a transmission medium via a network interface device (e.g., a network interface component included in the communication components 1064) and utilizing any one of a number of well-known transfer protocols (e.g., hypertext transfer protocol (HTTP)). Similarly, the instructions 1016 may be transmitted or received using a transmission medium via the coupling 1072 (e.g., a peer-to-peer coupling) to devices 1070. The term “transmission medium” shall be taken to include any intangible medium that is capable of storing, encoding, or carrying instructions 1016 for execution by the machine 1000, and includes digital or analog communications signals or other intangible medium to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

1. A system comprising:
a machine-readable medium storing computer-executable instructions; and
at least one hardware processor communicatively coupled to the machine-readable medium that, when the computer-executable instructions are executed, is configured to:
display a graphical calendar, the graphical calendar comprising a first plurality of selectable calendar dates;
receive a first selection of a first calendar date selected from the plurality of selectable calendar dates;
receive a second selection of a second calendar date selected from the plurality of selectable calendar dates;
in response to the received second selection, display a first graphical indication corresponding to a sequential time frame that includes a second plurality of selectable calendar dates selected from the first plurality of selectable calendar dates, the second plurality of selectable dates including the first calendar date and the second calendar date;
receive a third selection corresponding to a confirmation of the displayed first graphical indication; and
in response to the received third selection, locally broadcast an event corresponding to the sequential time frame.

2. The system of claim 1, wherein the at least one hardware processor is further configured to:
receive a first typed input corresponding to a first time associated with the first calendar date;
receive a second typed input corresponding to a second time associated with the second calendar date and,
wherein the sequential time frame includes the first typed input and the second typed input.

3. The system of claim 1, wherein the at least one hardware processor is further configured to:
receive a first typed input corresponding to a first time associated with the first calendar date;
receive a second typed input corresponding to a second time associated with the second calendar date;
determine whether the first typed input or the second typed input correspond to a valid time; and
in response to the determination that the first typed input or the second typed input are not a valid time, display a second graphical indication corresponding to an error in either the first typed input or the second typed input.

4. The system of claim 1, wherein:
the first selection of the first calendar date causes a first graphical change in the displayed graphical calendar;
the second selection of the second calendar date causes a second graphical change in the displayed graphical calendar; and
the first graphical change is different than the second graphical change.

5. The system of claim 1, wherein the at least one hardware processor is further configured to:
send a request for monitored data of an industrial asset based on the locally broadcasted event; and
display the monitored data of the industrial asset in response to the request.

6. The system of claim 1, wherein:
the sequential time frame includes a start date indicating a starting date for the sequential time frame and an ending date indicating an end date for the sequential time frame; and
the at least one hardware processor is further configured to:
assign the second calendar date as the start date and the first calendar date as the end date in response to a determination that the second calendar date occurs earlier in time than the first calendar date.

7. The system of claim 1, wherein the first calendar date is associated with a plurality of graphical states, each graphical state indicating a level of interactivity with the first calendar date; and
the first selection of the first calendar date causes the first calendar date to change from a first graphical state selected from the plurality of graphical states to a second graphical state selected from the plurality of graphical states.

8. A method comprising:
displaying, by at least one hardware processor, a graphical calendar, the graphical calendar comprising a first plurality of selectable calendar dates;
receiving, by the at least one hardware processor, a first selection of a first calendar date selected from the plurality of selectable calendar dates;
receiving, by the at least one hardware processor, a second selection of a second calendar date selected from the plurality of selectable calendar dates;
in response to the received second selection, displaying a first graphical indication corresponding to a sequential time frame that includes a second plurality of selectable calendar dates selected from the first plurality of selectable calendar dates, the second plurality of selectable dates including the first calendar date and the second calendar date;
receiving a third selection corresponding to a confirmation of the displayed first graphical indication; and
in response to the received third selection, locally broadcasting an event corresponding to the sequential time frame.

9. The method of claim 8, further comprising:
receiving a first typed input corresponding to a first time associated with the first calendar date;
receiving a second typed input corresponding to a second time associated with the second calendar date and;
wherein the sequential time frame includes the first typed input and the second typed input.

10. The method of claim 8, further comprising:
receiving a first typed input corresponding to a first time associated with the first calendar date;
receiving a second typed input corresponding to a second time associated with the second calendar date;
determining whether the first typed input or the second typed input correspond to a valid time; and
in response to the determination that the first typed input or the second typed input are not a valid time, displaying a second graphical indication corresponding to an error in either the first typed input or the second typed input.

11. The method of claim 8, wherein:
the first selection of the first calendar date causes a first graphical change in the displayed graphical calendar;
the second selection of the second calendar date causes a second graphical change in the displayed graphical calendar; and
the first graphical change is different than the second graphical change.

12. The method of claim 8, further comprising:
sending a request for monitored data of an industrial asset based on the locally broadcasted event; and
displaying the monitored data of the industrial asset in response to the request.

13. The method of claim 8, wherein:
the sequential time frame includes a start date indicating a starting date for the sequential time frame and an ending date indicating an end date for the sequential time frame; and
further comprising:
assigning the second calendar date as the start date and the first calendar date as the end date in response to a determination that the second calendar date occurs earlier in time than the first calendar date.

14. The method of claim 8, wherein the first calendar date is associated with a plurality of graphical states, each graphical state indicating a level of interactivity with the first calendar date; and
the first selection of the first calendar date causes the first calendar date to change from a first graphical state selected from the plurality of graphical states to a second graphical state selected from the plurality of graphical states.

15. A machine-readable medium storing computer-executable instructions that, when executed by at least one hardware processor, configures the at least one hardware processor to perform a plurality of operations, the operations comprising:
displaying a graphical calendar, the graphical calendar comprising a first plurality of selectable calendar dates;
receiving a first selection of a first calendar date selected from the plurality of selectable calendar dates;
receiving a second selection of a second calendar date selected from the plurality of selectable calendar dates;
in response to the received second selection, displaying a first graphical indication corresponding to a sequential time frame that includes a second plurality of selectable calendar dates selected from the first plurality of selectable calendar dates, the second plurality of selectable dates including the first calendar date and the second calendar date;
receiving a third selection corresponding to a confirmation of the displayed first graphical indication; and
in response to the received third selection, locally broadcasting an event corresponding to the sequential time frame.

16. The machine-readable medium of claim 15, wherein the plurality of operations further comprise:
receiving a first typed input corresponding to a first time associated with the first calendar date;
receiving a second typed input corresponding to a second time associated with the second calendar date and;
wherein the sequential time frame includes the first typed input and the second typed input.

17. The machine-readable medium of claim 15, wherein the plurality of operations further comprise:
receiving a first typed input corresponding to a first time associated with the first calendar date;
receiving a second typed input corresponding to a second time associated with the second calendar date;
determining whether the first typed input or the second typed input correspond to a valid time; and
in response to the determination that the first typed input or the second typed input are not a valid time, displaying a second graphical indication corresponding to an error in either the first typed input or the second typed input.

18. The machine-readable medium of claim 15, wherein:
the first selection of the first calendar date causes a first graphical change in the displayed graphical calendar;
the second selection of the second calendar date causes a second graphical change in the displayed graphical calendar; and
the first graphical change is different than the second graphical change.

19. The machine-readable medium of claim 15, wherein the plurality of operations further comprise:
sending a request for monitored data of an industrial asset based on the locally broadcasted event; and
displaying the monitored data of the industrial asset in response to the request.

20. The machine-readable medium of claim 15, wherein:
the sequential time frame includes a start date indicating a starting date for the sequential time frame and an ending date indicating an end date for the sequential time frame; and
the plurality of operations further comprise:
assigning the second calendar date as the start date and the first calendar date as the end date in response to a determination that the second calendar date occurs earlier in time than the first calendar date.
